(19) United States
(12) Patent Application Publication
(10) Pub. No.: US 2021/0097451 A1
(43) Pub. Date: Apr. 1, 2021

(54) INFORMATION PROCESSING APPARATUS, METHOD, AND PROGRAM

(71) Applicant: GURUNAVI, INC., Tokyo (JP)

(72) Inventor: Atsushi YAMADA, Tokyo (JP)

(73) Assignee: GURUNAVI, INC., Tokyo (JP)

(21) Appl. No.: 16/754,209

(22) PCT Filed: Sep. 27, 2019
(86) PCT No.: PCT/JP2019/038356

§ 371 Date: Apr. 7, 2020

(51) Int. Cl. G06Q 10/02; G06Q 10/10; G06Q 50/12; G06F 17/18

(52) U.S. Cl. CPC G06Q 10/02; G06Q 10/1093; G16Y 20/10; G06F 17/18; G06Q 50/12

(57) ABSTRACT

It is an object to provide an information processing apparatus in which an evaluation value of an in-site seat varies as necessary. The information processing apparatus 100 includes the storage unit 18, the receiving unit 15, and the CPU (calculation unit, control unit) 11. The storage unit 18 storage unit stores evaluation values of multiple seats. The receiving unit 15 receives a change of an environment. The calculation unit 11 calculates an effect of the change of the environment on each of the seats. The control unit 11 updates an evaluation value based on a calculation result. The receiving unit 15 receives an in-site environment from the multiple sensors 120 that detect the in-site environment. The CPU 11 updates the evaluation value based on the sensor information.

### TECHNICAL FIELD

The present invention relates to an information processing apparatus, a method, and a program. Particularly, the present invention relates to a seat evaluation value information processing, which is applicable to seat allocation for walk-in guests and seat reservation.

### BACKGROUND ART

Patent Literature 1 discloses an invention, whose object is to provide an evaluation value to an evaluation rater. According to a part of the disclosure of Patent Literature 1, an evaluation rater finds a product in a town and evaluates the product by using an evaluation device (smartphone, etc.), and then a cloud server varies an evaluation value of the product.

### CITATION LIST

### Patent Literature

Patent Literature 1: Japanese Patent Application Laid-open No. 2014-016842

### DISCLOSURE OF INVENTION

### Technical Problem

“To keep seats” at a restaurant for seat reservation and seat allocation for walk-in guests is assisted by an information technology. In such a technical field, according to a conventionally known information processing, seats or tables are kept in a certain order (not limited but, for example, order of reservation or order of visit).

Seats or tables at a restaurant or the like may have ranks or evaluation values depending on smoking seat/non-smoking seat areas, the acceptable number of people, good or bad view, and the like. Such ranks or evaluation values may be used for seat allocation for walk-in guests and seat reservation. Such ranks or evaluation values may be applicable for information processing. For example, customer groups having earlier reservations have reservation of use of tables having higher ranks, in order.

However, the customer satisfaction for seats is not completely in proportion to the evaluation values of the seats. The customer satisfaction for seats is not determined only based on the predetermined seat quality, but varies depending on various conditions and situations. For example, the customer satisfaction for a seat may be low when another guest sits on the next seat and the customer cannot enjoy dishes relaxed. To support various conditions and situations, it is necessary to vary evaluation values of seats depending on such various conditions and situations.

The present invention has been made in view of the aforementioned circumstances. It is an object to provide an information processing apparatus, a method, and a program, which which an evaluation value of an in-site seat varies as necessary.

### Solution to Problem

To attain the aforementioned object, according to an embodiment of the present invention, an information processing apparatus includes a storage unit, a receiving unit, a calculation unit, and a control unit.

The storage unit stores evaluation values of multiple seats.

The receiving unit receives a change of an environment.

The calculation unit calculates an effect of the change of the environment on each of the seats.

The control unit updates an evaluation value based on a calculation result.

According to the information processing apparatus, an evaluation value is updated depending on an environmental change. So an information processing apparatus with which an evaluation value of an in-site seat varies as necessary is provided.

According to the information processing apparatus, the receiving unit may receive an in-site environment from multiple sensors that detect the in-site environment, and the control unit may update the evaluation value based on sensor information.

According to the aforementioned configuration, an evaluation value of an in-site seat is updated as necessary depending on an in-site environment detected by a sensor.

According to the information processing apparatus, the receiving unit may further receive order information, and the control unit may update the evaluation value based on the received order information.

According to the aforementioned configuration, an evaluation value of an in-site seat is updated as necessary depending on what is ordered by an in-site guest.

According to the information processing apparatus, the control unit may update the evaluation value such that the evaluation value varies in a negative direction where the order information includes a predetermined order.

According to the aforementioned configuration, evaluation values of in-site seats other than a table with a predetermined order (for example, dishes with strong smell, etc.) vary in a negative direction. So guests are less likely to be guided to the surrounding seats based on the evaluation values. As a result, the guest who has the predetermined order may enjoy dishes and the like without being conscious of surrounding guest groups.

According to the information processing apparatus, the receiving unit may further receive guest group information generated based on reservation or visit of a guest group, and the control unit may update the evaluation value based on the guest group information.

According to the aforementioned configuration, an evaluation value of an in-site seat is updated as necessary depending on guest group information.

According to the information processing apparatus, the guest group information may include information of a number of people, and the control unit may update the evaluation value based on a size of the number of people.

According to the aforementioned configuration, an evaluation value of an in-site seat is updated as necessary depending on the number of people in a guest group. So, for example, evaluation values of surrounding seats around a guest group having a number of people are lowered, and seat allocation for a new guest group to the surrounding seats is thereby avoided. In this case, the guest group having a large number of people may enjoy dishes and the like without being conscious of surrounding guests.

According to the information processing apparatus, the guest group information may include attribute information of each customer, and the control unit may update the evaluation value based on the attribute information of each customer or a combination of the attribute information of multiple customers.

According to the aforementioned configuration, an evaluation value of an in-site seat is updated as necessary depending on an attribute such as sex or a predicted price per guest. So, for example, evaluation values of surrounding seats around seats (visited or reserved) for a guest group having a high price per guest are lowered, and seat allocation for a new guest group to the surrounding seats is thereby avoided. In this case, the guest group having a high price per guest may enjoy dishes and the like without being conscious of surrounding guests.

According to the information processing apparatus, the guest group information may include location information of a seat, and the control unit may update the evaluation value of a surrounding seat around the seat identified by the location information.

According to the aforementioned configuration, the in-site seats vary not uniform. Alternatively, surrounding seats (i.e., seats closer to seats with guest group) of a seat identified by location information may vary.

According to the information processing apparatus, the control unit may update the evaluation value of the surrounding seat such that a variance value of the evaluation value of the surrounding seat closer to the seat identified by the location information is larger.

According to the aforementioned configuration, the in-site seats vary not uniform. Alternatively, surrounding seats (i.e., seats closer to seats with guest group) of a seat identified by location information may vary.

According to the information processing apparatus, the guest group information may include a first time point, at which the guest group starts using a site, and the control unit may update the evaluation value of each seat such that a variance value of the evaluation value from a second time point to a third time point is larger, the second time point being a time point at which a predetermined time period has passed from the first time point, the third time point being a time point at which another predetermined time period has further passed.

According to the information processing realized by the aforementioned configuration, in a time period to the second time point (only a short time has passed after a guest group starts using seats) and in a time period after the third time point (closer to ending of the use time period), a new guest group is likely to use surrounding seats around the seats of the guest group.

According to the information processing apparatus, the calculation unit may calculate the variance value of the evaluation value from the second time point to the third time point depending on a combination of attribute information of customers included in the guest group information.

According to the aforementioned configuration, an evaluation value of a surrounding seat from the second time point to the third time point may be changed depending on attribute information of the guest group such as sex, the number of people, the age group, or the price per guest.

According to another embodiment of the present invention, there is provided an information processing method, including: storing evaluation values of multiple seats; receiving a change of an environment; calculating an effect of the change of the environment on each of the seats; and updating an evaluation value based on a calculation result.

According to the aforementioned embodiment, an evaluation value is updated depending on an environmental change. So an information processing method with which an evaluation value of an in-site seat varies as necessary is provided.

According to another embodiment of the present invention, there is provided a program that causes a computer to execute: the step of storing evaluation values of multiple seats; the step of receiving a change of an environment; the step of calculating an effect of the change of the environment on each of the seats; and the step of updating an evaluation value based on a calculation result.

According to the aforementioned embodiment, an evaluation value is updated depending on an environmental change. So a program with which an evaluation value of an in-site seat varies as necessary is provided.

### Advantageous Effects of Invention

According to the present invention, an information processing apparatus with which an evaluation value of an in-site seat varies as necessary is provided.

### BRIEF DESCRIPTION OF DRAWINGS

FIG. 1 A block diagram showing a configuration of an information processing system according to an embodiment of the present invention.

FIG. 2 A block diagram showing another configuration of an information processing system according to an embodiment of the present invention.

FIG. 3 A block diagram showing a hardware configuration of an information processing apparatus according to an embodiment of the present invention.

FIG. 4 A block diagram showing a configuration of a storage unit according to an embodiment of the present invention.

FIG. 5 An example of data stored in a table information database according to an embodiment of the present invention.

FIG. 6 Another example of data stored in a table information database according to an embodiment of the present invention.

FIG. 7 Another example of data stored in a table information database according to an embodiment of the present invention.

FIG. 8 An example of data stored in a guest group information database according to an embodiment of the present invention.

FIG. 9 An information processing flowchart according to an embodiment of the present invention.

FIG. 10 A diagram schematically illustrating starting and ending of a use time period according to an embodiment of the present invention.

### MODE(S) FOR CARRYING OUT THE INVENTION

Hereinafter, an embodiment of the present disclosure will be described with reference to the drawings.

[Information Processing System]

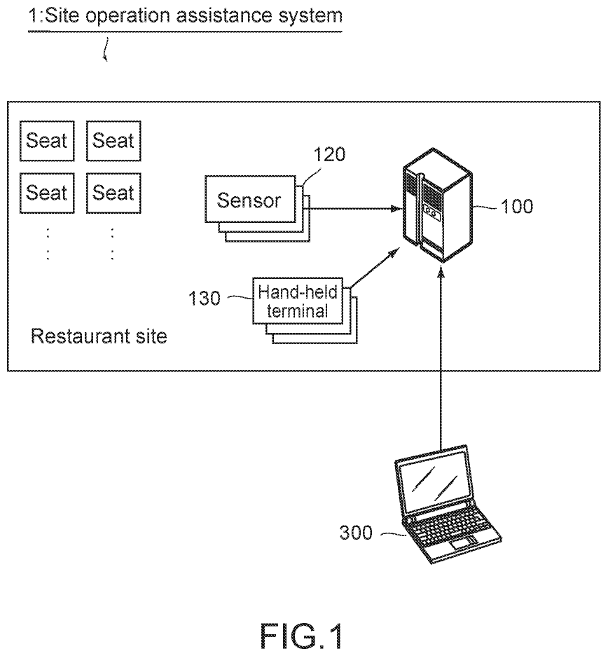

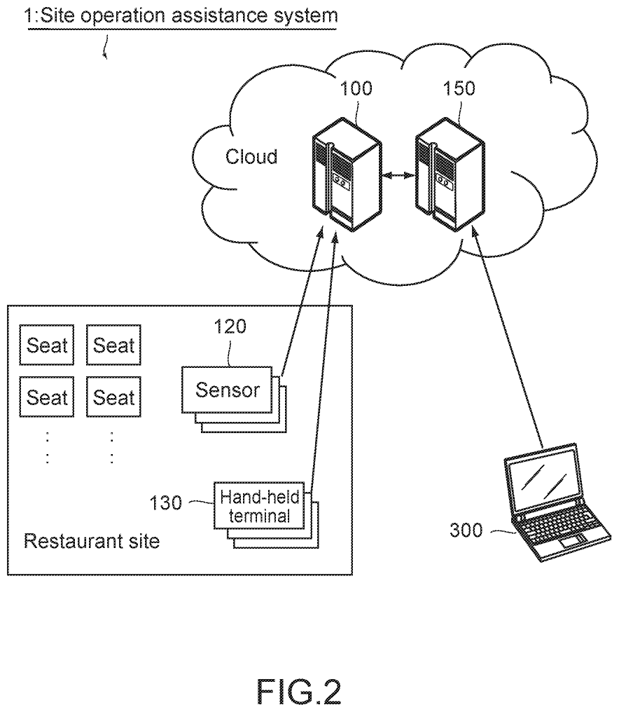

FIG. 1 and FIG. 2 show two configuration examples of an information processing system of the present embodiment. As shown in FIG. 1 and FIG. 2, the site operation assistance system 1 includes the information processing apparatus 100, the sensors 120, and the hand-held terminals 130. As shown in FIG. 2, the site operation assistance system 1 may further include, for example, the reservation acceptance server 150. FIG. 1 and FIG. 2 also show the customer terminal 300 outside the system.

The sensors 120 are means for inputting information of an in-site environment (hereinafter referred to as “environment information”) in the information processing apparatus 100. In the present embodiment, the sensors 120 includes a sensor group including, specifically, a microphone, a motion sensor, a camera, a temperature sensor, a humidity sensor, an optical sensor (for example, sensor configured to detect an amount of light by using a photoelectric transducer), and a sensor that detects an operation status of an in-site device. Note that the sensor that detects an operation status of an in-site device is a sensor that monitors the switch on/off setting, the temperature, the volume of air, and the like of an in-site device such as an air conditioner. In another embodiment, in place of the sensor 120, an on-table order acceptance terminal (not shown) may provide a function similar to the function of the sensor 120. In this case, the order acceptance terminal may recognize a guest's order via voice recognition and input information in the information processing apparatus 100.

The hand-held terminal 130 is an example of a means for inputting customer information in the information processing apparatus 100. The hand-held terminal 130 may be, specifically, a mobile terminal operated by a worker configured to receive an order. The worker inputs information of walk-in guests in the hand-held terminal 130, and the hand-held terminal 130 inputs the input information in the information processing apparatus 100.

The customer terminal 300 is also an example of a means for inputting customer information in the information processing apparatus 100. The customer terminal 300 may be, specifically, a general-purpose computer, a smartphone, or the like. A customer provides reservation information via the customer terminal 300 to the site operation assistance system 1. The provided information may be directly input in the information processing apparatus 100 (FIG. 1) or may be input via the reservation acceptance server 150 (FIG. 2).

In FIG. 1, the information processing apparatus 100 of the present embodiment is provided in each restaurant site. In this case, the site operation assistance system 1 is a complete in-site information processing system. In FIG. 2, the information processing apparatus 100 of the present embodiment is provided as one of a cloud server group. In such a configuration, a different server (the reservation acceptance server 150) may execute information processing of reservation acceptance.

[Information Processing Apparatus]

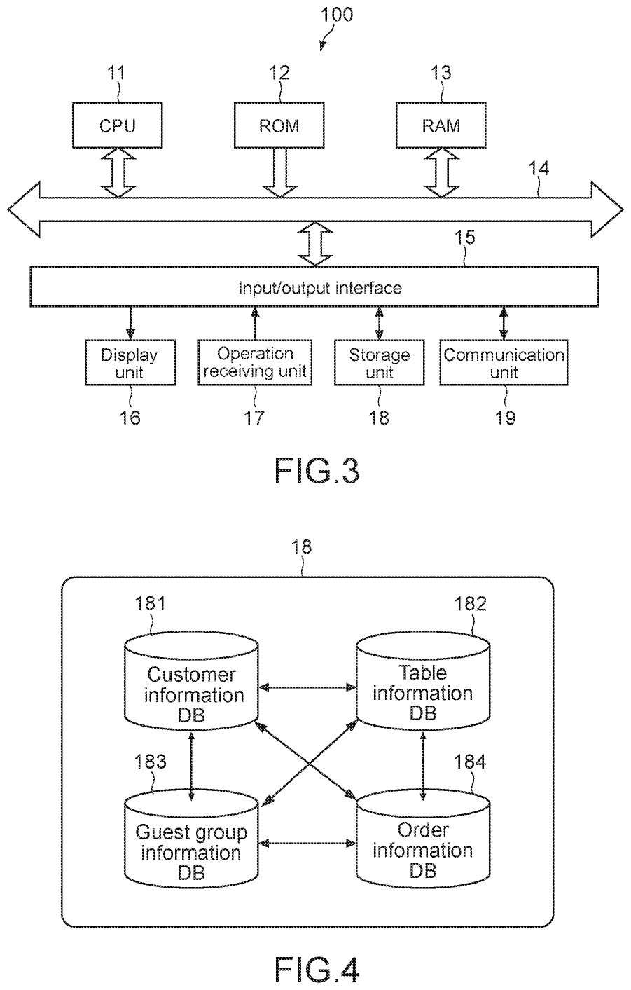

FIG. 3 is a block diagram showing a hardware configuration of the information processing apparatus 100 of the present embodiment. As shown in FIG. 3, the information processing apparatus 100 includes the CPU (Central Processing Unit) 11, the ROM (Read Only Memory) 12, the RAM (Random Access Memory) 13, the input/output interface 15, and the bus 14 connecting them.

The CPU 11 appropriately accesses the RAM 13 and the like as necessary, executes various arithmetic processing, and controls the respective blocks entirely. The ROM 12 is a nonvolatile memory in which an OS (Operating System), programs, and firmware with various parameters executable by the CPU 11 are fixedly stored. The RAM 13 is used as a work area and the like of the CPU 11, and temporarily stores the OS, various applications being executed, and various data being processed.

The input/output interface 15 is connected to the display unit 16, the operation receiving unit 17, the storage unit 18, the communication unit 19, and the like. The display unit 16 is a display device that uses, for example, an LCD (Liquid Crystal Display), an OELD (Organic Electro-Luminescence Display), a CRT (Cathode Ray Tube), or the like. The operation receiving unit 17 is, for example, a pointing device such as a mouse, a keyboard, and another input device.

Note that the display unit 16 and the operation receiving unit 17 may be a single liquid crystal touch panel.

The storage unit 18 is a nonvolatile memory such as, for example, an HDD (Hard Disk Drive), a flash memory (SSD; Solid State Drive), or another solid memory. The storage unit 18 stores the OS, the various applications, and the various data.

The communication unit 19 includes various modules for wireless communication such as, for example, an NIC (Network Interface Card) or a wireless LAN. The apparatus is capable of sending and receiving data to and from another apparatus by using the communication unit 19.

Further, the CPU 11 loads software programs stored in the ROM 12 to operate as the control unit, the calculation unit, and the like of the present invention. The storage unit 18 functions as the storage unit of the present invention. The input/output interface 15 functions as the receiving unit of the present invention.

The information processing apparatus 100 of the present embodiment employs the aforementioned hardware configuration, and is thereby capable of processing information input from the sensor 120, the hand-held terminal 130, the reservation acceptance server 150, and the like collectively.

[Data of Storage Unit]

The storage unit 18 stores various data. Data that relates to the configuration and operation of the present embodiment will be described.

FIG. 4 shows an example of a data structure of various data structure stored in the storage unit 18. As shown in FIG. 4, the storage unit 18 includes the customer information database 181, the table information database 182, the guest group information database 183, and the order information database 184.

The databases are in relation with each other, and are structured as one relational database as a whole. Note that this is an example for convenience of description. In another embodiment, they may not be a relational database or may be a simple storage table.

The customer database 181 is a database that stores information of customers of one site or a group of sites of the common brand. The table information database 182 is a database that stores information of in-site tables, seats, and the like. The guest group information database 183 is a database that stores groups of users who visit the site. The order information database 184 is a database that stores information of dishes and the like ordered by each guest group.

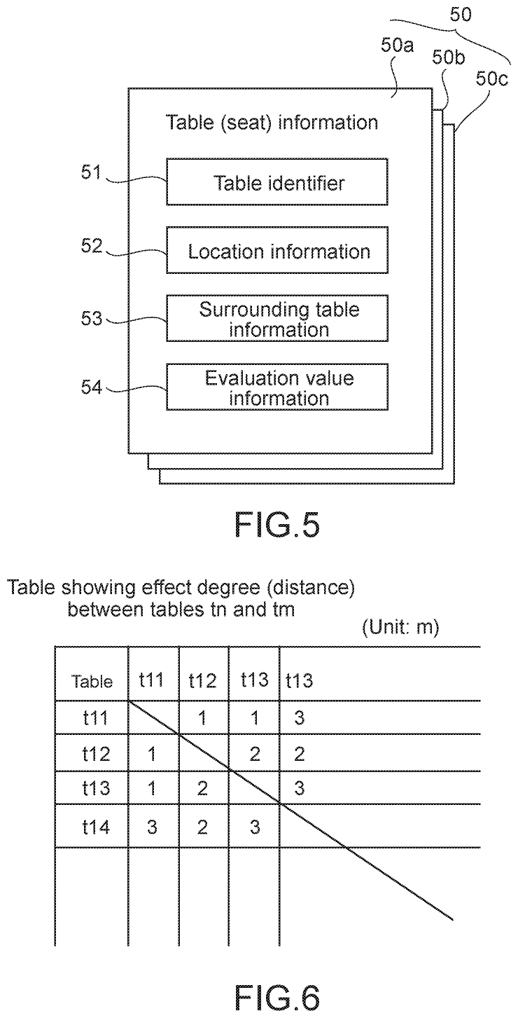

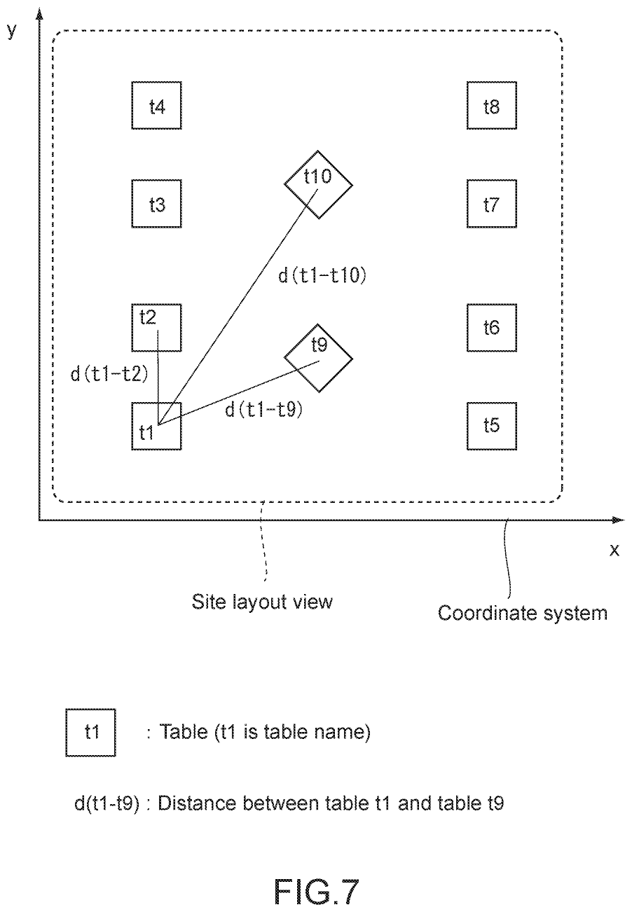

FIG. 5, FIG. 6, and FIG. 7 shows an example of the data structure stored in the table information database 182. As shown in the table (seat) information 50a, 50b, and 50c of FIG. 5, the table information database 182 stores the table (seat) information 50 for each table or seat.

The table (seat) information 50 includes the table identifier 51 unique to each table or seat. The table (seat) information 50 further includes, for each table identifier 51, the location information 52, the surrounding table information 53, and the evaluation value information 54.

The location information 52 is information of the in-site location of the table identified by the table identifier 51. In the present embodiment, the location information 52 is a location coordinate of a plan layout view, which is a top view of a site (described later with reference to FIG. 7). However, an example of the location information 52 is not limited to the location coordinate of the present embodiment, and may be information of another type.

The surrounding table information 53 is information of tables around the table identified by the table identifier 51. A surrounding table is somewhat affected by the table identified by the table identifier 51 when a guest group sits at the table. The surrounding table information 53 includes the table identifier 51 of each surrounding tables, and further includes effect degree information when a guest group sits at the table. The smaller the distance, the larger the effect degree. So the effect degree information of the present embodiment is the distance between the table identified by the table identifier 51 and each surrounding table.

FIG. 6 is a table that shows effect degree information of respective tables of the surrounding table information 53. In FIG. 6, the distance between two tables tn and tm stands for the effect degree as it is. In FIG. 6, the effect degree of the table t11 to the table t12 is 1. The effect degree to the table t14 is 3. The table information database 182 stores the table of FIG. 6.

The evaluation value information 54 is an evaluation value information being an index indicating the comfort degree, the seat rank, and the like. The default value of the evaluation value information 54 is determined based on the seat rank. In the present embodiment, the CPU 11 of the information processing apparatus 100 updates the evaluation value information 54 based on an environmental change.

FIG. 7 shows an example of a plan layout view (so-called site layout view) on the x-y plane location coordinate system, which is a top view of a site. In the present embodiment, the location information 52 is the x-y coordinate of a position (for example, center point of table, corner point of table, or the like) capable of identifying the location of a table shown in FIG. 7.

In FIG. 7, “d(tn-tm)” stands for the distance between tables, for example. The CPU 11 calculates the distance d(tn-tm) between tables respectively, and obtains the surrounding table information 53 of FIG. 6. For example, the surrounding table information 53 of the table t1 includes d(t1-t2), d(t1-t3), . . . d(t1-t10). It is easy to calculate the distance between two points on the x-y coordinate. So the CPU 11 is capable of easily creating the information table of the distance between two seats of FIG. 6 based on the site layout view on the location coordinate system of FIG. 7.

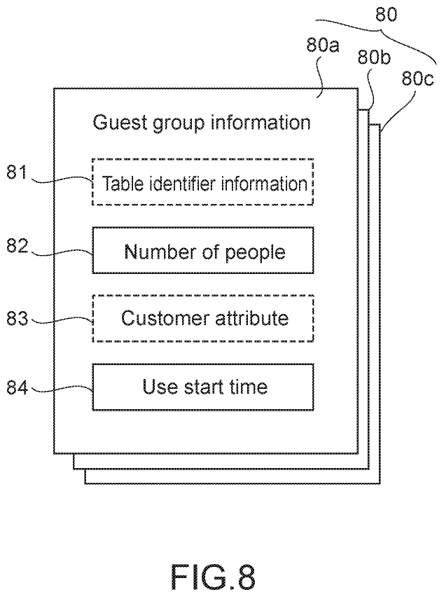

FIG. 8 shows an example of a data structure stored in the guest group information database 183. As shown in the guest group information 80a, 80b, or 80c of FIG. 8, the guest group information database 183 stores the guest group information 80 for each guest group.

The guest group information 80 includes the table identifier 51 (may be multiple) for each guest group that identifies the table (reserved table, or table in use) secured for the guest group. The guest group information 80 further includes the number of people 82, the customer attribute 83, and the use start time 84.

The table identifier information 81 is information that identifies the table identifier 51 stored in the table information database 182. When the guest group uses two or more tables, the table identifier information 81 includes two or more table identifiers 51. Since the guest group information 80 includes the table identifier information 81, the CPU 11 is capable of determining the table in use or to be used by the guest group with reference to the guest group information 80.

The number of people 82 is information of the number of people of the guest group. The number of people may be one. The customer attribute 83 is attribute information of the guest group such as sex, the number of people, the age group, or the price per guest. The customer attribute 83 of a walk-in guest is generated based on information (for example, information such as “age 30 to 39, male”) input by a worker at the site via the hand-held terminal 130. The customer attribute 83 of a guest with reservation is generated based on information input in the reservation acceptance server 150 by the guest with reservation at the time of reservation. The use start time 84 is information of the time at which the guest group starts using the site.

[Information Processing]

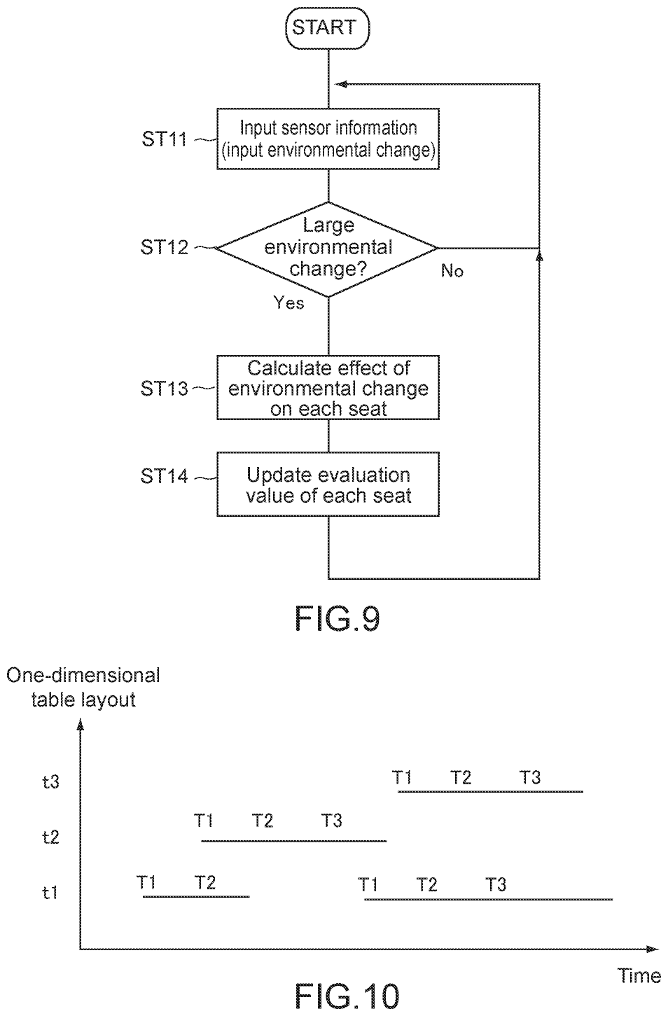

FIG. 9 shows a flowchart of information processing of the present embodiment. The CPU 11 executes the information processing of FIG. 9 as necessary.

Firstly, the CPU 11, which functions as a control unit and a calculation unit, and the communication unit 19 and the input/output interface 15, which function as a receiving unit, receive an environmental change input from the sensor 120, the hand-held terminal 130, the reservation acceptance server 150, and the like (Step 11). Step 11 will be described later in detail. In the information processing flow of the present embodiment described here, information (sensor information) detected by the sensor 120 is input as an example of the environmental change.

The CPU 11 determines whether or not the input environmental change is larger than a predetermined threshold (Step 12). In the present example described here, the environmental change is information detected by the sensor 120. In this case, the CPU 11 determines whether the change amount of the sensing data is larger than or smaller than a predetermined threshold. Where the CPU 11 determines that the input environmental change is not larger than the predetermined threshold, the CPU 11 returns to Step 11 and receives input of the environmental change (Step 12, No). In Step 12, the CPU 11 determines that the subsequent processing will not be executed where the environmental change is smaller than the predetermined threshold. So a redundant calculation amount may be lowered.

Meanwhile, if it is determined that the input environmental change is large (Step 12, Yes), the CPU 11 calculates, for each seat, an effect of the environmental change input in Step 11 on each seat, the effect being information having a direction and a value such as +10 points or −5 points (Step 13). In the present embodiment, the CPU 11 calculates effects of a seat on all the seats. Alternatively, the CPU 11 may specify a seat with an environmental change before calculation, and calculate an effect only on a surrounding seat around the specified seat. When the CPU 11 calculates an effect only on a surrounding seat around the specified seat, a redundant calculation amount may be lowered.

Next, the CPU 11 updates the evaluation value of each seat based on the effect on each seat calculated in Step 13 (Step 14). In Step 14, the CPU 11 adds the information (information of seat) having a direction and a value calculated in Step 13 to the evaluation value information 54 of the table (seat) information 50, for example. As a result, the CPU 11 updates the evaluation value of each seat.

[Environmental Change Input]

The “environmental change” input in Step 11 of FIG. 9 will be described. In the present embodiment, the environmental change mainly includes a variance of information input from the sensor 120, a variance of the guest group information database 183, and a variance of the order information database 184.

Examples of the variance of information input from the sensor 120 include a voice volume (loud voice of predetermined decibel or more), presence/absence on a table or a seat, image information, and the like detected by the sensors 120 including a microphone, a motion sensor, and a camera. The CPU 11 may determine that there is a large environmental change in the vicinity of the table on which the sensor 120 is provided when a loud voice of a predetermined volume or more is continued for a predetermined time period or more in Step 12.

Examples of the variance of the order information database 184 include addition of new order information and the like. In the information processing apparatus 100, the communication unit 19 receives the new order information input from the hand-held terminal 130, and adds the new order information to the order information database 184. In this case, the CPU 11 may determine whether or not the order information includes a predetermined order, for example, dishes having a strong smell, and determine that there is a large environmental change in the vicinity of the table with that order in Step 12.

The dish having a strong smell is an example of the predetermined order, but this is not the limitation. Another example of the environmental change based on the variance of the order information database 184 is a case where a predetermined volume or more of alcohols and liquors is ordered.

Where it is determined that there is the predetermined order, the CPU 11 may further calculate the effect on the evaluation value calculated in Step 13 in the negative direction. In this case, a predetermined order includes dishes with a strong bad smell. Meanwhile, where the predetermined order is with a strong appetizing smell for a customer of a surrounding group, the CPU 11 may calculate the effect on the evaluation value in a positive direction.

Examples of the variance of the guest group information database 183 include generation of the new guest group information 80 by the hand-held terminal 130 based on a walk-in guest who visits the site, and generation of the new guest group information 80 based on reservation of the customer terminal 300 and the reservation acceptance server 150. In addition, when the CPU 11 inquires the customer information database 181 of the customer attribute 83 of the guest group information 80 and obtains the customer attribute 83, a variance of the guest group information database 183 is generated.

Each guest group information 80 has the use start time 84 set. The CPU 11 may determine whether or not there is a large environmental change at the use start time 84 or at a time point at which a predetermined time period has passed after the use start time 84 in Step 12.

The CPU 11 may determine whether or not there is a large environmental change based on the size of the number of people 82 with reference to the number of people 82 of the guest group information 80 newly generated or updated in Step 12. As a result, the following information processing may be enabled. For example, a group of a large number of people may be noisy and a surrounding group may feel uncomfortable. So evaluation values of surrounding seats are lowered, and allocation of such seats for new groups is thereby avoided.

The CPU 11 may determine whether or not there is a large environmental change based on the data of the customer attribute 83 with reference to the customer attribute 83 of the guest group information 80 newly generated or updated in Step 12. The guest group information 80 may include the multiple customer attributes 83. The CPU 11 may determine as described above based on the customer attribute 83 of each customer, or may determine as described above based on the combination of the multiple customer attributes 83.

For example, the CPU 11 may determine in Step 12 and calculate the effect in Step 13 based on the guest group information 80 mainly including customers of a certain sex out of the attributes.

[Evaluation Value Use]

As described above, in the present embodiment, the evaluation value of each table is updated as necessary and varies. The evaluation value of each table is applicable to automatic seat allocation of a new guest group. The CPU 11 keeps use of a table having a high evaluation value in the reservation order or visit order of a new guest group, or in the rank order of a customer based on the customer attribute 83. The information processing for keeping use of a table is, for example, realized by allocating the table identifier information 81 to the guest group information 80 newly generated.

[Effect Calculation]

The “effect on each seat” calculated in Step 13 of FIG. 9 will be described. In the present embodiment, the effect on each seat is not uniform for all the seats, but is different depending on the location of each seat. Firstly, the CPU 11 determines a table or a seat having an environmental change, and then calculates an effect on each seat based on location information and distance information of FIG. 6.

In the present embodiment, where it is determined that there is a large environmental change (Step 12, Yes), the CPU 11 determines a table or a seat with the environmental change. Where an environmental change is detected based on a variance of information input from the sensor 120, the CPU 11 determines the table, which is the position on which the sensor 120 is provided, as a table with the environmental change. Where an environmental change is detected based on a variance of the guest group information database 183, the CPU 11 determines a table, which is identified by the table identifier 51 indicated by the table identifier information 81 of the guest group information 80 having a direct relation with the variance, as the table with the environmental change. Where an environmental change is detected based on a variance of the order information database 184, the CPU 11 determines a table, which is identified by the table identifier 51 indicated by the table identifier information 81 of the guest group information 80 of a guest group who orders dishes having a direct relation with the variance, as the table with the environmental change.

The CPU 11 calculates an effect on each seat with reference to the table information database 182 such as the table (seat) information 50 of the determined table. Note that the CPU 11 may calculate an effect only on a surrounding table where only the surrounding table around the table with the environmental change has an effect on an evaluation value. The CPU 11 calculates an effect on each seat as described above. So a redundant calculation amount may be lowered.

Further, the CPU 11 calculates an effect on each seat depending on the distance from the determined table, i.e., such that a variance value of the evaluation value of the seat closer to the determined table is larger, based on the table of FIG. 6 stored in the table information database 182. For example, the CPU 11 calculates evaluation values with variances, i.e., the effect of 100% on the table having the distance 1, the effect of 50% on the table having the distance 2, and the effect of 34% on the table having the distance 3.

Further, the CPU 11 calculates an effect of an environmental change in Step 13 as follows. Firstly, the CPU 11 calculates a reference value (for example, information having a direction and a value such as +10 points or −5 points). Next, the CPU 11 calculates a value (information having a direction and a value) with the difference of the effect for each table (seat).

Further, in the present embodiment, the CPU 11 calculates an effect of an environmental change in Step 13 not only with reference to the distance between tables (seats) as described above but also with reference to the time period in which a guest group uses the table. FIG. 10 schematically illustrates starting and ending of a use time period described below.

In FIG. 10, the horizontal axis shows time and the vertical axis shows the relation between tables one-dimensionally. The table layout is illustrated two-dimensionally in a plan view. However, FIG. 10 illustrates the table layout one-dimensionally for convenience of description. For example, in FIG. 10, the table t1 is next to the table t2, and the table t2 is next to the table t1 and to the table t3.

In FIG. 10, a line shows a time period length of a guest group at a table. Each guest group starts using the table at the first time point T1 (same as the use start time 84). Where the site type is a pub, there may be a timing, at which a group has a busy conversation and has a large effect on surroundings, after a certain time period passes from the use start time point. The second time point T2 is such a timing. Further, the third time point T3 is a time point at which the group may generally finish a dining time. Different time points are set depending on types. Where the type is a pub, the second time point T2 is the time point after 0.5 hour, and the third time point T3 is the time point after 2 hours, for example.

The starting of the use time period is from the first time point T1 to the second time point T2. The ending of the use time period is after the third time point T3.

The CPU 11 calculates an effect on each seat every time an environmental change is detected such that an effect of an environmental change of the table on each surrounding seat from T2 to T3 (busy conversation and large effect on surroundings) is larger than an effect of an environmental change of the table on each surrounding seat before T2 or after T3. Specifically, the CPU 11 calculates a variance of the evaluation value information 54 in Step 13 such that the variance ratio, which corresponds to the environmental change detected from T2 to T3, is larger than the variance ratio, which corresponds to the environmental change detected in other time periods (before T2 and after T3). The CPU 11 calculates an effect on each seat in this manner, and surrounding tables around a noisy group having a party or the like are thereby reliably evaluated negative. So the surrounding tables may not be kept for use of new guest groups. The present guest group may enjoy dishes and the like without being conscious of surrounding guest groups.

Further, the CPU 11 calculates a variance of the evaluation value information 54 in Step 13 such that the variance ratio, which corresponds to the environmental change detected after T3, is smaller than the variance ratio, which corresponds to the environmental change detected before T3. According to this configuration, an effect of the environmental change is small in the time period after T3. As a result, in the ending of the use time period, unnecessary avoidance of a table around the table for a new group is avoided. In other words, a surrounding table is likely to be kept for a new group. So, as shown in FIG. 10, in the ending of the use time period of a guest group at a table “b”, a new guest group is likely to sit at the next table “a”. According to this configuration, the site operation efficiency is appropriately maintained.

### Modification Examples

It should be understood by those skilled in the art that various modifications, combinations, sub-combinations and alterations may occur.

For example, in the aforementioned embodiment, an example of an environmental change based on a variance of information input from the sensor 120 is a case where a voice volume having a predetermined threshold or larger is continued for a predetermined time period or more. The present invention is not limited to that. An environmental change based on a variance of information input from the sensor 120 may be another phenomenon.

For example, when the sensor 120 including an optical sensor and a temperature sensor detects that the lightness and temperature of a window-side table rise abruptly, the CPU 11 determines that there is a large environmental change in Step 12. Next, the CPU 11 lowers the evaluation value of the window-side table. Further, the CPU 11 lowers an evaluation value of each table depending on the distance from the window. According to a method realized by this configuration, when a table has a strong sunlight, an evaluation value of an in-site seat varies as necessary.

Further, for another example, the sensor 120, which includes a sensor for detecting an operation status of an in-site device, detects that the temperature set for an air conditioner or the volume of air is suddenly changed (predetermined ratio or more). In this case, the CPU 11 determines that there is a large environmental change in Step 12. Next, the CPU 11 lowers evaluation values of some tables. According to a method realized by this configuration, when a table has a strong wind from an air conditioner, such a situation is detected and an evaluation value of an in-site seat varies as necessary. Further, the sensor 120 includes a temperature sensor, and the temperature sensor detects that the temperature around some tables decreases abruptly. In addition, the sensor, which detects the operation status of the in-site device, detects that a lower temperature (for example, 23 degrees or lower) is set for the air conditioner. In this case, the CPU 11 determines that there is a large environmental change in Step 12, and lowers the evaluation values of some tables. Such a configuration may be employed. According to a method realized by this configuration, when some in-site tables has a strong wind from the air conditioner, such a situation is detected and an evaluation value of an in-site seat varies as necessary.

Further, for another example, the sensor 120 includes a humidity sensor, a temperature sensor, and the like configured to detect exterior humidity and temperature of a site, and detects raining. In this case, the CPU 11 determines that there is a large environmental change in Step 12. Next, the CPU 11 lowers evaluation values of an exterior table and a window-side table affected by raining. According to a method realized by this configuration, in a case of sudden raining, such a situation is detected and an evaluation value of an in-site seat varies as necessary. Further, the CPU 11 may access a weather forecast website or the like of the Internet, and collect weather information such as raining of the current time and thereafter. According to this configuration, the evaluation value of an exterior table is previously lowered, and thereby appropriate seat allocation for appropriate guest with reservation is enabled.

Note that a software program that enables the information processing disclosed above is applicable. Such a program may be provided with a magnetic or optical recording medium, or may be downloaded via a telecommunication line.

### REFERENCE SIGNS LIST

1 site operation assistance system

11 CPU

12 ROM

13 RAM

14 bus

15 input/output interface

16 display unit

17 operation receiving unit

18 storage unit

19 communication unit

181 customer information database

182 table information database

183 guest group information database

100 information processing apparatus

120 sensor

150 reservation acceptance server

1-13. (canceled)

14. An information processing apparatus, comprising:
a storage configured to store evaluation values of multiple seats;
a receiving circuitry configured to receive a change of an environment;
a calculation circuitry configured to calculate an effect of the change of the environment on each of the seats; and
a control circuitry configured to update an evaluation value based on a calculation result, wherein
the receiving circuitry is further configured to receive guest group information generated based on reservation or visit of a guest group, the guest group information including location information of a seat, and
the control circuitry is configured to update the evaluation value based on the guest group information, and update the evaluation value of a surrounding seat around the seat identified by the location information.

15. The information processing apparatus according to claim 14, wherein
the receiving circuitry is configured to receive an in-site environment from multiple sensors that detect the in-site environment, and
the control circuitry is configured to update the evaluation value based on sensor information.

16. The information processing apparatus according to claim 14, wherein
the receiving circuitry is further configured to receive order information, and
the control circuitry is configured to update the evaluation value based on the received order information.

17. The information processing apparatus according to claim 16, wherein
the control circuitry is configured to update the evaluation value such that the evaluation value varies in a negative direction where the order information includes a predetermined order.

18. The information processing apparatus according to claim 14, wherein
the guest group information includes information of a number of people, and
the control circuitry is configured to update the evaluation value based on a size of the number of people.

19. The information processing apparatus according to claim 14, wherein
the guest group information includes attribute information of each customer, and
the control circuitry is configured to update the evaluation value based on the attribute information of each customer or a combination of the attribute information of multiple customers.

20. The information processing apparatus according to claim 14, wherein
the control circuitry is configured to update the evaluation value of the surrounding seat such that a variance value of the evaluation value of the surrounding seat closer to the seat identified by the location information is larger.

21. The information processing apparatus according to claim 14, wherein
the guest group information includes a first time point, at which the guest group starts using a site, and
the control circuitry is configured to update the evaluation value of each seat such that a variance value of the evaluation value from a second time point to a third time point is larger, the second time point being a time point at which a predetermined time period has passed from the first time point, the third time point being a time point at which another predetermined time period has further passed.

22. The information processing apparatus according to claim 21, wherein
the calculation circuitry is configured to calculate the variance value of the evaluation value from the second time point to the third time point depending on a combination of attribute information of customers included in the guest group information.

23. An information processing apparatus, comprising:
a storage configured to store evaluation values of multiple seats;
a receiving circuitry configured to receive a change of an environment including a change of an in-site environment from multiple sensors that detect the in-site environment;
a calculation circuitry configured to calculate an effect of the change of the environment on each of the seats based on sensor information, the sensor information being detection information of the sensors; and
a control circuitry configured to update an evaluation value based on a calculation result of the calculation unit.

24. An information processing method, comprising:
storing evaluation values of multiple seats;
receiving a change of an environment;
calculating an effect of the change of the environment on each of the seats; and
updating an evaluation value based on a calculation result, wherein
the receiving includes further receiving guest group information generated based on reservation or visit of a guest group, the guest group information including location information of a seat, and
the updating the evaluation value includes updating the evaluation value based on the guest group information, and updating the evaluation value of a surrounding seat around the seat identified by the location information.

25. An information processing method, comprising:
storing evaluation values of multiple seats in a storage;
receiving a change of an environment including a change of an in-site environment from multiple sensors that detect the in-site environment;
calculating an effect of the change of the environment on each of the seats based on sensor information, the sensor information being detection information of the sensors; and
updating an evaluation value based on a calculation result of calculating..

26. A non-transitory computer-readable storage medium storing a program that causes the computer to execute:
storing evaluation values of multiple seats in a storage;
receiving a change of an environment;
calculating an effect of the change of the environment on each of the seats; and
updating an evaluation value based on a calculation result, wherein
the receiving includes further receiving guest group information generated based on reservation or visit of a guest group, the guest group information including location information of a seat, and
the updating the evaluation value includes updating the evaluation value based on the guest group information, and updating the evaluation value of a surrounding seat around the seat identified by the location information.

27. A non-transitory computer-readable storage medium storing a program that causes the computer to execute:
storing evaluation values of multiple seats in a storage;
receiving a change of an environment including a change of an in-site environment from multiple sensors that detect the in-site environment;
calculating an effect of the change of the environment on each of the seats based on sensor information, the sensor information being detection information of the sensors; and
updating an evaluation value based on a calculation result of the step of calculating.
